(19) United States
(12) Patent Application Publication
(10) Pub. No.: US 2013/0234986 A1
(43) Pub. Date: Sep. 12, 2013

(54) STYLUS ADAPTED FOR LOW RESOLUTION TOUCH SENSOR PANELS

(71) Applicant: APPLE INC., Cupertino, CA (US)

(72) Inventor: John G. ELIAS, Townsend (DE)

(73) Assignee: Apple Inc., Cupertino, CA (US)

(21) Appl. No.: 13/857,886

(22) Filed: Apr. 5, 2013

Related U.S. Application Data
(62) Division of application No. 12/172,052, filed on Jul. 11, 2008, now abandoned.

(51) Int. Cl. G06F 3/044

(52) U.S. Cl. CPC G06F 3/044
USPC 345/174

(57) ABSTRACT

Methods and apparatus adapted to ensure that contact from a stylus will be detected on a low resolution touch sensor panel irrespective of the location of the region of contact upon the touch surface. In some examples, a metallic or otherwise conductive disk may be attached to one end of the stylus. The disk may be sized so as to guarantee sufficient electrical interaction with at least one sensory element of the touch sensor panel. In some examples, the stylus may be powered so as to provide a stimulus signal to the capacitive elements. Optionally, one or more force and/or angle sensors disposed within the stylus can supply additional data to the touch panel.

### FIELD OF THE INVENTION

The present invention relates generally to the field of touch detection. More particularly, the present invention is directed in one exemplary aspect to providing a stylus adapted for use with a capacitive touch sensor panel optimized for finger detection.

### BACKGROUND OF THE INVENTION

Many types of input devices are presently available for performing operations in a computing system, such as buttons or keys, mice, trackballs, joysticks, touch sensor panels, touch screens and the like. Touch screens, in particular, are becoming increasingly popular because of their ease and versatility of operation as well as their declining price. Touch screens can include a touch sensor panel, which can be a clear panel with a touch-sensitive surface, and a display device such as a liquid crystal display (LCD) that can be positioned partially or fully behind the panel so that the touch-sensitive surface can cover at least a portion of the viewable area of the display device. Touch screens can allow a user to perform various functions by touching the touch sensor panel using a finger, stylus or other object at a location dictated by a user interface (UI) being displayed by the display device. In general, touch screens can recognize a touch event and the position of the touch event on the touch sensor panel, and the computing system can then interpret the touch event in accordance with the display appearing at the time of the touch event, and thereafter can perform one or more actions based on the touch event.

Touch sensor panels are typically fabricated as one or more layers of thin film deposited and patterned into conductive regions upon at least one layer of a transparent substrate. The conductive regions include a number of capacitive elements arranged into a plurality of rows and columns. When a user's finger contacts a specific region of the touch surface, the approximate location of the user's finger can be determined based upon analysis of one or more sensed signals.

A low resolution array of row and column elements is usually sufficient for finger detection. This is because the width of the typical human finger is relatively large (roughly 10 mm) in relation to at least one dimension of a capacitive element. Therefore, if it is known in advance that the touch sensor panel will primarily be driven by finger input, fewer capacitive elements can be built into the touch sensor panel. Additionally, the rows and columns can be separated at a greater distance.

However, when a stylus is subsequently employed on a touch sensor panel optimized for finger input, the stylus's small tip can often contact a region of the touch surface that is between adjacent capacitive elements (e.g., as between adjacent column sensors). Since the tip of the stylus is not sufficiently wide so as to guarantee the level of electrical interaction necessary for it to be sensed by at least one capacitive element, many situations exist where the touch sensor panel will not be able to identify an input even if the stylus is making contact with the touch surface.

### SUMMARY OF THE INVENTION

In many conventional touch sensor panels, capacitive elements are arranged into a plurality of rows and columns so as to service an entire region of a touch surface. By analyzing the state of each column sensor after a particular row has been driven, a centroid can be calculated indicating the approximate position of a contacting entity upon the touch surface.

In many cases, however, the small tip of a stylus will contact a region of the touch surface that is between adjacent sensors (for example, as in certain low resolution touch sensor panels that are adapted for finger input). Without sufficient electrical interaction with at least one sensory element, a centroid may not be properly identified, and hence the input will not be recognized. Various examples of the present invention therefore ensure that contact from the stylus will be detected on a low resolution touch sensor panel irrespective of the location of the region of contact upon the touch surface.

In some examples, a metallic or otherwise conductive disk may be attached to one end of the stylus. The disk may be sized so as to guarantee sufficient electrical interaction with at least one sensory element of the touch sensor panel. In some examples, the disk may be attached to one end of the stylus via a pivotal connector. This increases the likelihood that the disk will remain flush with the touch surface as the user applies different combinations of directional forces to the stylus.

In some examples, the stylus may be powered so as to provide a stimulus signal to the capacitive elements. In this manner, the capacitive elements do not need to be driven continuously within a host device. Optionally, one or more force and/or angle sensors disposed within the stylus can supply additional data to the touch panel. This additional data can be used for selecting various features in an application executing on the host device (e.g., selecting various colors, brushes, shading, line widths, etc.).

### BRIEF DESCRIPTION OF THE DRAWINGS

FIG. 1 illustrates an exemplary stylus adapted for use with a host device according to one example of the present invention.

FIG. 2 is a diagram illustrating components of an exemplary stylus according to one example of the present invention.

FIG. 3 is a diagram illustrating how an exemplary stylus including a rigid tip can yield a non-uniform signal.

FIG. 4A is a diagram illustrating an exemplary disk pivot adapted to ensure that a conductive disk remains flush with a touch surface according to one example of the present invention.

FIG. 4B is a diagram illustrating an exemplary disk pivot adapted to ensure that a conductive disk remains flush with a touch surface according to one example of the present invention.

FIG. 4C is a diagram illustrating an exemplary disk pivot adapted to ensure that a conductive disk remains flush with a touch surface according to one example of the present invention.

FIG. 5 is a diagram illustrating an exemplary stylus including a conductive disk emanating a set of fringe fields according to one example of the present invention.

FIG. 6 is a diagram illustrating components of an exemplary stylus according to another example of the present invention.

FIG. 7 is a diagram illustrating an exemplary single-sided indium tin oxide circuit 700 adapted to detect stimulus signals generated by a powered stylus according to one example of the present invention.

FIG. 8 is a flow diagram illustrating an exemplary method of automatically selecting a mode of operation for input detection according to one example of the present invention.

FIG. 9 is a block diagram illustrating an exemplary computing system including a touch sensor panel adapted for use with one example of the present invention.

FIG. 10A is a block diagram illustrating an exemplary mobile telephone having a touch sensor panel adapted for use with a powered stylus according to one example of the present invention.

FIG. 10B is a block diagram illustrating an exemplary digital media player having a touch sensor panel adapted for use with a powered stylus according to one example of the present invention.

FIG. 10C is a block diagram illustrating an exemplary personal computer having a touch sensor panel (trackpad) and/or display adapted for use with a powered stylus according to one example of the present invention.

### DETAILED DESCRIPTION OF THE PREFERRED EXAMPLES

In the following description of preferred examples, reference is made to the accompanying drawings which form a part hereof, and in which it is shown by way of illustration specific examples in which the invention can be practiced. It is to be understood that other examples can be used and structural changes can be made without departing from the scope of the examples of this invention.

As used herein, the term “application” includes without limitation any unit of executable software which implements a specific functionality or theme. The unit of executable software may run in a predetermined environment; for example, a downloadable Java Xlet™ that runs within the JavaTV™ environment.

As used herein, the terms “computer program” and “software” include without limitation any sequence of human or machine cognizable steps that are adapted to be processed by a computer. Such may be rendered in any programming language or environment including, for example, C/C++, Fortran, COBOL, PASCAL, Perl, Prolog, Python, MATLAB, assembly language, scripting languages, markup languages (e.g., HTML, SGML, XML, VoXML), functional languages (e.g., APL, Erlang, Haskell, Lisp, ML, F# and Scheme), as well as object-oriented environments such as the Common Object Request Broker Architecture (CORBA), Java™ (including J2ME, Java Beans, etc.).

As used herein, the term “display” includes any type of device adapted to display information, including without limitation cathode ray tube displays (CRTs), liquid crystal displays (LCDs), thin film transistor displays (TFTs), digital light processor displays (DLPs), plasma displays, light emitting diodes (LEDs) or diode arrays, incandescent devices, and fluorescent devices. Display devices also include less dynamic devices such as printers, e-ink devices, and other similar structures.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), and PSRAM.

As used herein, the term “module” refers to any type of software, firmware, hardware, or combination thereof that is designed to perform a desired function.

As used herein, the terms “processor,” “microprocessor,” and “digital processor” include all types of digital processing devices including, without limitation, digital signal processors (DSPs), reduced instruction set computers (RISC), general-purpose (CISC) processors, microprocessors, gate arrays (e.g., FPGAs), programmable logic devices (PLDs), reconfigurable compute fabrics (RCFs), array processors, and application-specific integrated circuits (ASICs). Such processors may be contained on a single unitary IC die or distributed across multiple components.

As used herein, the term “network” refers generally to any type of telecommunications or data network including, without limitation, cable networks, satellite networks, optical networks, cellular networks, and bus networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, hybrid fiber coaxial, etc.) and/or communications or networking protocols (e.g., SONET, DOCSIS, IEEE Std. 802.3, ATM, X.25, Frame Relay, 3 GPP, 3 GPP2, WAP, SIP, UDP, FTP, RTP/RTCP, TCP/IP, H.323, etc.).

As used herein, the term “wireless” refers to any wireless signal, data, communication, or other interface including, without limitation, Wi-Fi, Bluetooth, 3 G, HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, analog cellular, CDPD, satellite systems, millimeter wave or microwave systems, acoustic, and infrared (i.e., IrDA).

In many conventional touch sensor panels, capacitive elements are arranged into a plurality of rows and columns so as to service an entire region of a touch surface. By analyzing the state of each column sensor after a particular row has been driven, a centroid can be calculated indicating the approximate position of a contacting entity upon the touch surface.

In many cases, however, the small tip of a stylus will contact a region of the touch surface that is between adjacent sensors (for example, as in certain low resolution touch sensor panels that are adapted for finger input). Without sufficient electrical interaction with at least one sensory element, a centroid may not be properly identified, and hence the input will not be recognized. Various examples of the present invention therefore ensure that contact from the stylus will be detected on a low resolution touch sensor panel irrespective of the location of the region of contact upon the touch surface.

In some examples, a metallic or otherwise conductive disk may be attached to one end of the stylus. The disk may be sized so as to guarantee sufficient electrical interaction with at least one sensory element of the touch sensor panel. In some examples, the disk may be attached to one end of the stylus via a pivotal connector. This increases the likelihood that the disk will remain flush with the touch surface as the user applies different combinations of directional forces to the stylus.

In some examples, the stylus may be powered so as to provide a stimulus signal to the capacitive elements. In this manner, the capacitive elements do not need to be driven continuously within a host device. Optionally, one or more force and/or angle sensors disposed within the stylus can supply additional data to the touch panel. This additional data can be used for selecting various features in an application executing on the host device (e.g., selecting various colors, brushes, shading, line widths, etc.).

Although examples of the invention may be described and illustrated herein in terms of touch sensor panels, it should be understood that examples of this invention are not so limited, but are additionally applicable to any module adapted to determine input via capacitive sensing. Furthermore, although examples of the invention may be described and illustrated herein in terms of indium tin oxide (ITO) touch sensor panels, it should be understood that examples of the invention are not so limited, but are also applicable to other conductive media as well. This includes, without limitation, amorphous silicon, copper indium diselenide, cadmium telluride, and film crystalline silicon.

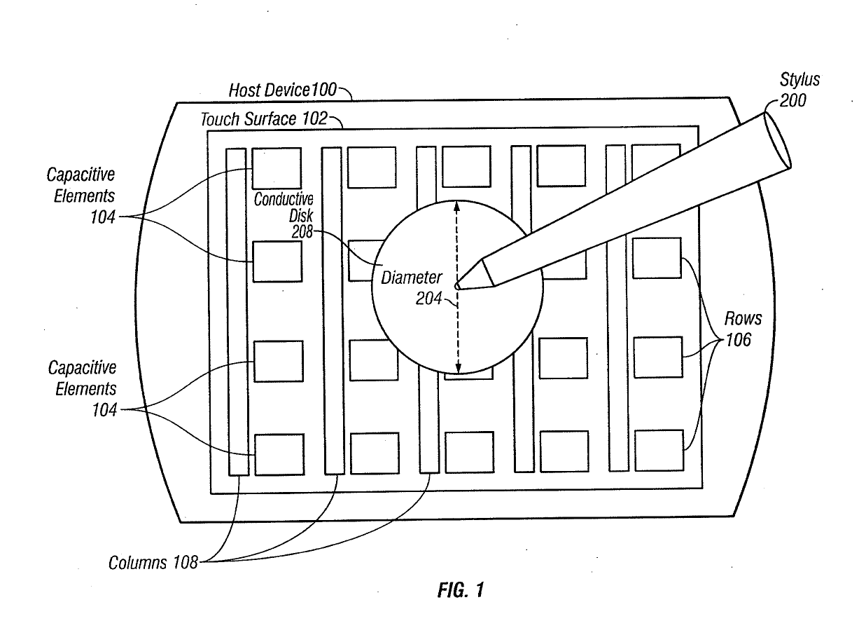

FIG. 1 illustrates an exemplary stylus 200 adapted for use with a host device 100 according to one example of the present invention. As shown by the figure, the host device 100 includes a touch surface 102 that is serviced by a plurality of capacitive elements 104 arranged into a plurality of rows 106 and columns 108. Note, however, that even though FIG. 1 depicts the capacitive elements 104 arranged in this particular manner, other configurations of capacitive elements 104 are also possible according to examples of the present invention.

When the stylus 200 makes contact with the touch surface 102, one or more capacitive elements 104 undergo a change in capacitance that can be detected by charge amplifier circuitry. These sensors define a crude two-dimensional “patch” which represents the “image” of the touch provided by the stylus. From the shape and dimensions of the patch, a centroid can be calculated which represents an approximate center of the touch area. Once the centroid has been calculated, its position can then be transmitted to an application resident on the host device 100 for input processing.

As shown by FIG. 1, the stylus 200 includes a conductive disk 208 with a diameter 204 large enough to ensure sufficient electrical interaction with a minimum number of capacitive elements 104 for the purposes of centroid calculation. In this manner, a centroid may be calculated irrespective of the position of the conductive disk 208 upon the touch surface 102.

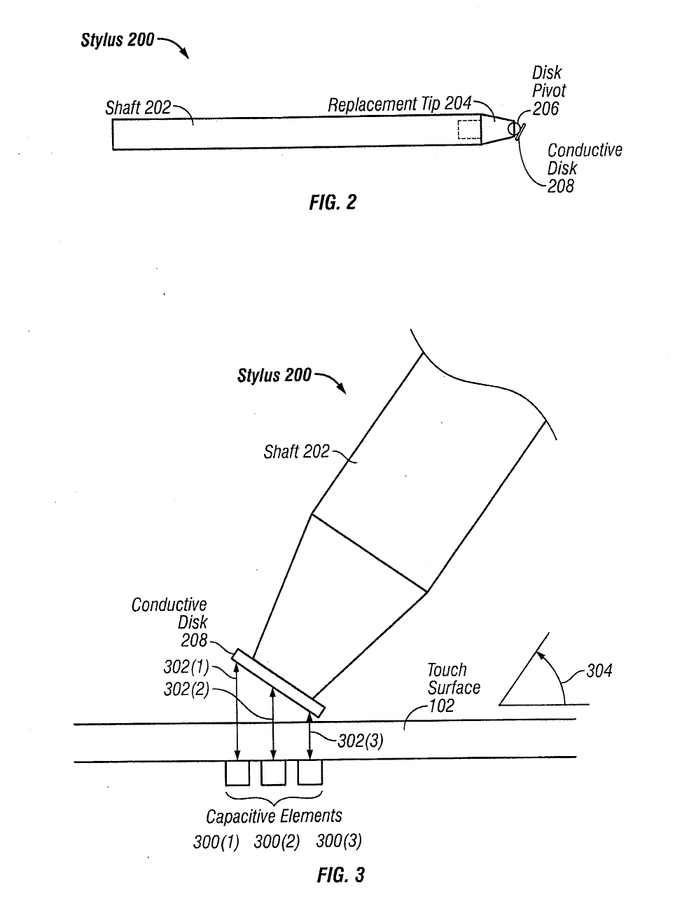

FIG. 2 is a diagram illustrating components of an exemplary stylus 200 according to one example of the present invention. As shown by the figure, the exemplary stylus 200 of FIG. 2 includes a shaft 202, a replacement tip 204, and a conductive disk 208 attached to a disk pivot 206 that is connected to the replacement tip 204.

In one example, the shaft of the stylus 200 has a length of approximately 130 millimeters and a diameter of approximately 8 millimeters, although any set of dimensions may be utilized according to examples of the present invention. Additionally, the shape of the shaft may be of any shape or geometry including, for example, rectangular and cylindrical shapes.

In some examples, the shaft 202 contains a conductive material such as a metal or a metal alloy (e.g., aluminum or copper). The conductive material in the shaft 202 allows the user's body to extend the conductor upon contact with the shaft 202, thus facilitating current flow from the user's body to the conductive disk 206 and providing a ground path for charge coupled onto the conductive disk from the touch sensor panel. In some examples, this allows for stronger signal detection at the touch sensor panel.

In other examples, the shaft 202 contains an insulating material such as plastic or glass. In some examples, the insulating material in the shaft 202 serves to prevent electrical noise picked up by the user's body from being transmitted to the touch surface. This electrical noise can interfere with the input detection mechanism of the touch sensor panel.

In some examples, a detachable replacement tip 204 may be attached to one end of the shaft 202. The replacement tip 204 includes a disk pivot 206 and a conductive disk 208. Since the diameter of the conductive disk is optimized for a particular spatial resolution of a touch sensor panel (as discussed in further detail below), replacement tips 204 having conductive disks 208 of different diameters 204 enable a single stylus 200 to operate on a variety of touch sensor panels with different spatial resolutions. Additionally, the shafts 202 of styli 100 can be manufactured independently from the replacement tips 204, thereby reducing the costs of manufacture.

In several examples, a disk pivot 206 increases the likelihood that the conductive disk 208 will remain flush with the touch surface 102 as various directional forces are applied to the stylus 200 during operation. In some examples, the disk pivot 206 can provide a uniform interaction with sensory elements for the purposes of centroid calculation. If the conductive disk 208 were instead rigidly attached to the shaft 202, then the varying distances between each region of the conductive disk 208 and each corresponding capacitive element could in some cases result in inaccurate touch detection and a shifted centroid.

FIG. 3 is a diagram illustrating this phenomenon. As the stylus 200 is oriented at an angle 304 relative to the touch surface 102, a set of distances 302(1), 302(2), and 302(3) separate regions of the conductive disk 208 from the corresponding capacitive elements 300(1), 302(2), and 303(3) beneath them. As FIG. 3 indicates, the distance from the conductive disk 208 to each capacitive element 300(1), 300(2), and 302(3) progressively decreases as the disk approaches the touch surface 102. Since the conductive disk 208 is rigidly connected to the shaft 202, one side of the conductive disk 208 will elevate from the touch surface 102 as the angle 304 formed between the shaft 202 and the touch surface 102 approaches 0 degrees from the vertical position.

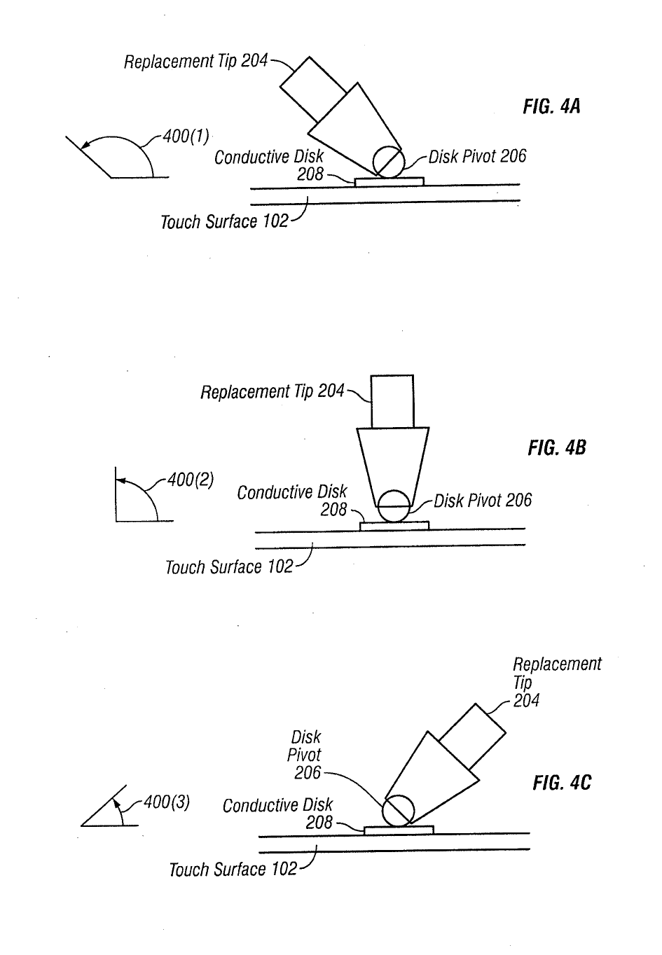

FIGS. 4A-4C are diagrams illustrating an exemplary disk pivot 206 that increases the likelihood that the conductive disk 208 will remain flush with the touch surface 102 according to one example of the present invention. As shown by the figure, the replacement tip 204 rotates about the disk pivot 206 as the angle of application 400 changes from 400(1) to 400(2) and 400(3). In this manner, amount of charge is greatest at the electrodes situated closest to the center of the disk, thus ensuring proper centroid calculation.

As illustrated by FIG. 2, a conductive disk 208 may be attached to one side of the disk pivot 206. Note that even though a conductive disk 208 is depicted in FIG. 2, the contact member may include other surface shapes and/or geometries according to various examples of the present invention. This includes without limitation elliptical and polygonal surfaces (e.g., square and rectangular surfaces). In one example, the contact member includes a conductive sphere adapted to simultaneously serve as the disk pivot 206.

The conductive disk 208 (or other such contact member) is adapted to electrically interact with one or more electrodes disposed within a touch sensor panel. In order to ensure sufficient electrical interaction with enough electrodes so as to generate a centroid, the conductive disk 208 may appropriately sized. The size of the disk 208 or other contact member depends in part upon the size of each electrode in the touch sensor panel and the distance between adjacent electrodes. For example, in touch sensor panels with higher spatial resolutions (i.e., with less space separating each adjacent electrode) the conductive disk 208 may have a smaller diameter (e.g., four millimeters). By contrast, in touch sensor panels with lower spatial resolutions (i.e. with more space separating each adjacent electrode), the conductive disk 208 may have a greater diameter (e.g., seven millimeters).

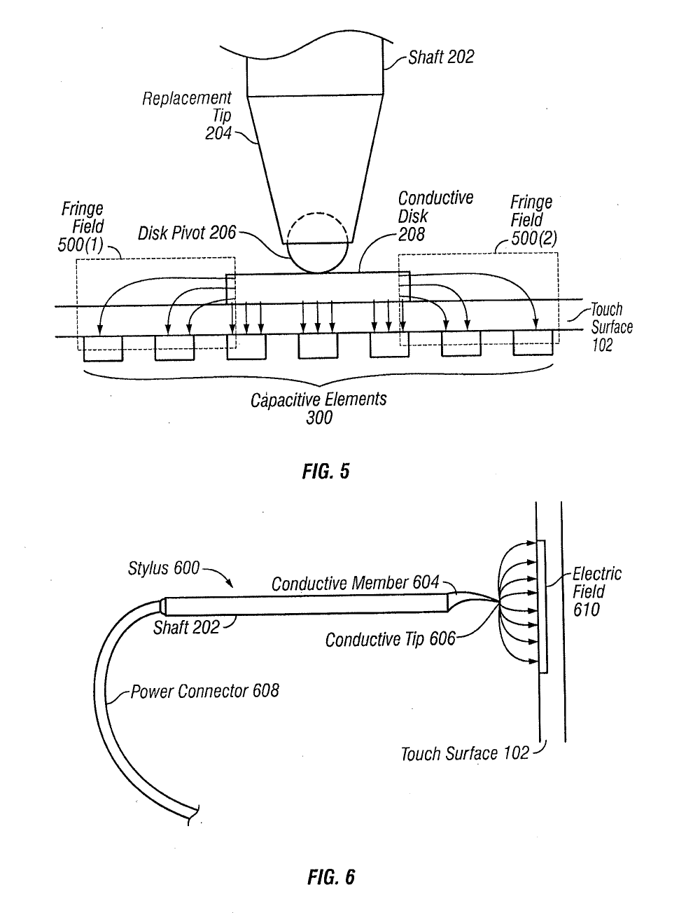

According to certain examples, the size of the conductive disk 208 depends on other factors as well. For example, FIG. 5 illustrates an exemplary stylus 200 including a conductive disk 208 with an associated set of fringe fields 500(1) and 500(2). In some examples, the fringe fields 500 are sufficiently strong so as to charge capacitive elements adjacent to those situated beneath the region of contact. In this manner, the strength and spread of the fringe fields 500 may be taken into account when calculating the size of the conductive disk 208 or other contact member.

In some examples, the size of the conductive disk 208 or other contact member also depends upon additional functionality supported by the stylus 200. For example, in some examples, the stylus 200 includes one or more embedded accelerometers adapted to transmit positional information to the touch sensor panel. Positional information generated by the capacitive elements 300 may be synthesized with the accelerometer data by a processor in the host device in order to derive the precise region of contact upon the touch surface 102. In some of these examples, the capacitive touch circuitry is required only to generate a rough indication of the location of the conductive disk 208 upon the touch surface 102, while the high precision information is provided by the one or more accelerometers. Thus, the conductive disk 208 need not electrically interact with as many capacitive elements as would be necessary to calculate a high precision centroid using the capacitive elements alone. In this manner, the conductive disk 208 may be sized so as to take this into account.

FIG. 6 is a diagram of components of an exemplary stylus 600 according to another example of the present invention. The stylus 600 includes a shaft 202 and a conductive member 604 with a conductive tip 606. A power connector 608 such as a conductive cable may be adapted to transmit current to the stylus 600, thereby increasing the voltage between the conductive tip 606 and capacitive elements situated behind the touch surface 102. The strength of the electric field 610 generated is a function of the applied voltage. Note that the power supplied to the stylus 600 via the power connector 608 can be specified according to the power necessary for a designated number of capacitive elements to be able to sufficiently detect the generated electric field 610.

The spread of the electric field 610 is a function of the shape and/or sharpness of the conductive tip 606. In some examples, a sharp tip may be utilized in order to increase the spread of the electric field 610 such that it is detected by some predetermined number of capacitive elements (e.g., at least three capacitive elements). In this manner, a powered stylus 600 can generate an electric field 610 both strong enough and wide enough so as to enable calculation of a high precision centroid. Note also that any number of tip shapes and/or geometries may be used according to examples of the present invention. Additionally, any number of conductive materials may be used within the power connector 608, the shaft 202, and/or the conductive member 604. This includes without limitation metallic substances such as aluminum, gold, silver and copper.

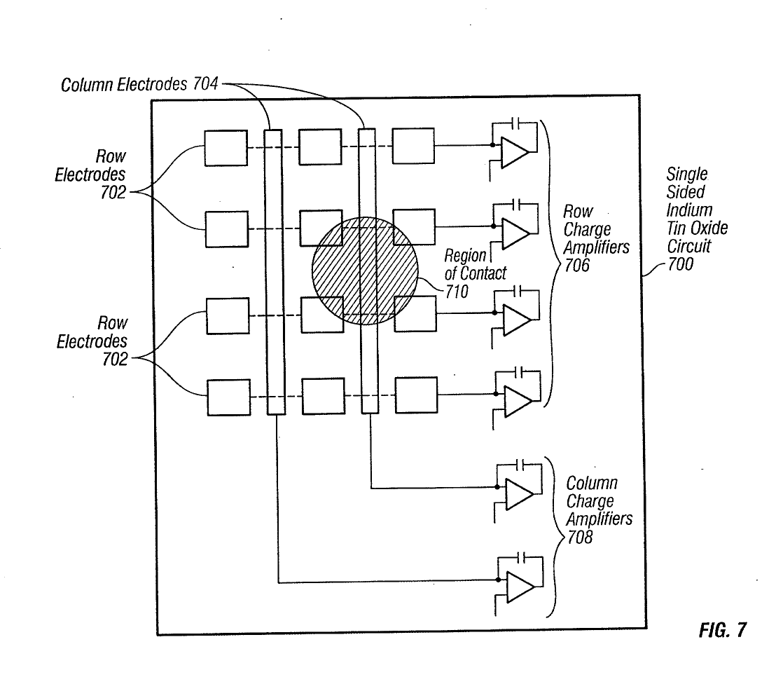

FIG. 7 is a diagram illustrating an exemplary single-sided indium tin oxide (SITO) circuit 700 adapted to detect stimulus signals generated by a powered stylus according to one example of the present invention. As shown by the figure, the SITO circuit 700 includes a number of row electrodes 702 and a number of column electrodes 704 adapted to service a certain region of a touch sensor panel. Note that the connections between adjacent row electrodes are shown symbolically as dashed lines in FIG. 7. The actual connections may take on any number of configurations, including, for example, connecting traces that are routed to metal traces in the border areas of the panel, or vias that allows the connections to pass over or under the column electrodes in a different layer. For simplicity of illustration, not all row and column electrodes included within the SITO 700 circuit are illustrated in FIG. 7; in some examples, for example, the SITO circuit 700 includes ten columns and fifteen rows. Note, however, that any number of rows electrodes 702 and column electrodes 704 may be utilized according to examples of the present invention. Additionally, the size of each electrode as well as the spacing between each electrode may vary across examples.

In many conventional SITO circuits, the rows are progressively driven while the columns are set to sense signals. The column electrodes may be connected to a set of column charge amplifiers adapted to amplify sensed signals. Charge coupled from the driven row to the sense column can be detected by the charge amplifiers. Touch events cause a change in the charge coupling, and this change can be detected by the charge amplifier as a touch event. The locations (and optionally the magnitudes) of the sensed changes in charge coupling at a particular instant in time are then used for centroid calculation by a processor in the host device. Note that in some SITO circuits, all electrodes are scanned in order to process simultaneous contacts upon the touch surface (for example, as in the case of multi-touch applications adapted to calculate a plurality of centroids from a number of interactions with the touch surface 102).

With a powered stylus, however, it becomes unnecessary to continuously drive the row electrodes since the stylus can provide the requisite stimulus signals. As such, the row electrodes can be provided a set of row charge amplifiers 706 in addition to the conventional column charge amplifiers 708 associated with the column electrodes 704. In this manner, both the row electrodes 702 and the column electrodes 704 can be set to sense changes in charge coupling, where the stimulus signal is provided by the powered stylus.

Additionally, according to certain examples, only a single region of contact 710 (i.e., calculation of a single centroid) may be necessary for an application executing on the host device 100. This is because many applications adapted to receive input from a stylus do not require multi-touch capability. In some of these examples, since there is no frame scanning as would be the case in finger tracking acquisition mode, the signal recording rate can be greatly increased so as to allow more signal averaging or to track very fast motion. The data processing burden may also be reduced since there may be a smaller number of signals to analyze (n+m signals as compared to n*m signals, where n is the number of rows and m is the number of columns in the touch panel). In addition to these computational efficiencies, power may also be preserved.

In some examples, the SITO circuit 700 may be adapted to automatically switch modes of operation (for example, as between a stylus mode, where both the rows and columns are set to sense, and a finger mode, where either the rows or the columns are set to drive, while the other is set to sense).

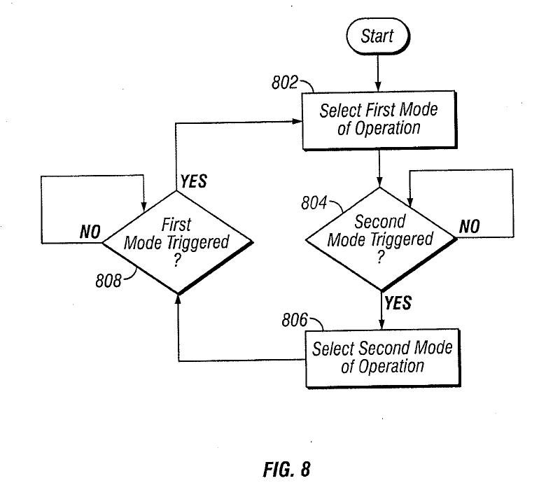

FIG. 8 is a flow diagram illustrating an exemplary method of automatically selecting a mode of operation for input detection according to one example of the present invention. At block 802, a first mode of operation is selected. In some examples, the mode of operation defaults to the first mode of operation when the host device 100 is powered on.

At block 804, a processor within the host device continuously determines whether the second mode of operation has been triggered. In some examples, this may be accomplished by determining whether one or more parameters of a detected centroid satisfy certain criteria. For example, in one example, if a detected centroid corresponds to a region of contact 710 with an estimated diameter of approximately ten millimeters, the system may assume that a finger is presently contacting the touch surface 102 and adjust the mode of operation accordingly. Alternatively, if the detected centroid corresponds to a region of contact 710 with a smaller estimated diameter, the system may assume that a stylus is contacting the touch surface 102.

In alternative examples, other techniques may be employed. For example, in some examples, the presence of multiple contacts upon the touch surface 102 may be used to support a determination that the first mode of operation should be retained. In some examples, mode selection may be based in part upon the strength of the signal detected by one or more sense electrodes. Other techniques may also be utilized according to examples of the present invention.

Once the second mode of operation has been triggered, it is correspondingly selected at block 806. The system then continuously detects whether the first mode of operation has been triggered at block 808 and the process repeats per step 802. Note that in some examples, the criteria used to determine whether the first mode is triggered at step 808 is different than the criteria used at step 804. Note also that one or more temporal values may be used for restoring a prior selected mode of operation. For example, in one example, a finger mode may be automatically restored one minute from the time that a stylus mode is selected.

In several examples, a powered stylus may be further adapted to provide additional information to the host device 100 for subsequent processing. For example, in certain examples, the stylus includes one or more squeeze (force) sensors, switches, buttons and/or other toggles adapted to allow a user to quickly select among various types of associated functionality (for example, selecting colors, brush sizes, shading, line width, eraser functionality, etc.).

In some examples, stylus functionality may be determined based upon output from one or more sensory modules adapted to estimate at least one angle of inclination. The sensory modules include, without limitation, accelerometers, force sensors, motion sensors, pressure sensors, and other similar devices. In some examples, the angle of inclination is an estimated angle of the position of the shaft 202 relative to the touch surface 102. Note that in some examples, angles may be estimated about more than one axis.

In some examples, stylus functionality may be automatically selected based upon one or more estimated angles of inclination. For example, in one example, if a stylus is oriented at an angle smaller than 45 degrees or at an angle greater than 225 degrees relative to the touch surface 102 about at least one axis, a larger brush size is automatically selected. Alternatively, a stylus 200 contacting a touch surface 102 may be adapted to navigate among a plurality of selections upon a display screen, thus functioning in a manner similar to a joystick.

In some examples, stylus functionality may be determined based upon output from one or more sensory modules adapted to estimate the amount of force applied in a direction that is perpendicular to the touch surface 102. Any number or combination of modules may be used for this purpose, including, for example, force sensors, pressure sensors, accelerometers, strain gauges, piezoelectric sensors, etc.

In one example, for example, the width of the line output on an associated display screen is a function of the amount of force applied to the stylus 200 against the touch surface 102. Thus, if a small amount of dynamic force is applied to the stylus in a direction perpendicular to the touch surface 102, an application resident on the host device 100 may generate a thin line on an associated display screen. Conversely, if a large amount of dynamic force is applied to the stylus, the application may output a thicker line.

In another example, the amount of force applied to the stylus 200 against the touch surface 102 is adapted to trigger one or more power states of the stylus 200. For example, a stylus 200 operating in a low power state may automatically switch to a higher power state upon detecting an inertial force exerted upon the conductive disk 208 or other contact member. The low power state may subsequently be restored when the inertial force is no longer detected.

A variety of information transfer methods may be used to convey functional information associated with a particular configuration of the stylus 200 to an application resident in the host device 100. This information includes, without limitation, the state of one or more buttons, switches or other similar toggles; data indicating the output from one or more sensory modules (e.g., estimated angles of inclination, data generated by squeeze sensors, estimated forces applied in a direction perpendicular to the touch surface 102, etc.); and fine positional data adapted to complement data generated by the capacitive elements disposed within the SITO circuit 700. In some examples, a stylus stimulus frequency may be used to select one or more stylus functions. For example, in one example, toggling a particular setting in the stylus 200 modulates the frequency of the stimulating signal. One or more modules resident in the host device 100 may then be used to determine the function based upon the detected frequency.

In other examples, the stylus 200 communicates to the system by stimulation voltage levels. In some examples, for example, analog stimulation voltage levels are utilized. In this manner, the specific function selected may be predicated on the applied voltage at a given instant or over a given period of time. In other examples, the stylus 200 communicates to the system using a digital stimulation voltage stream. In one example, for example, a stimulation pattern of high and low voltage pulses is adapted to transmit information to the host device 100. In another example, a simulation pattern of single-level voltage pulses is adapted to convey this information. One or more demodulation and analysis modules resident in the host device 100 may then be used to derive the selected function from detected voltage conditions. These modules may include any combination of hardware, software, and/or firmware.

In still other examples, information may be conveyed to the host device 100 via one or more wireless network connections. For example, in some examples, one or more embedded accelerometers provide fine resolution information to the host device 100 for the purposes of centroid calculation. As the stylus 200 kinetically contacts the touch surface, the capacitive position information may be integrated with the accelerometer data in order to maintain a high-resolution position of the region of contact 710. This enables a sharper end stylus to operate with the SITO circuit 700 while simultaneously providing positional information which significantly exceeds the spatial resolution capability of the capacitive touch sensor panel.

In some examples, one or more accelerometers allow tracking of the conductive disk 208 or conductive tip 606 above the touch surface (i.e., Z direction tracking). The Z-directional information determined by the accelerometers may be used, for example, to verify whether there is contact with the touch surface 102, to determine whether a gesture-based function has been performed by a user, to select a particular setting on the host device 100, to navigate among a plurality of display screens, or to transition between power states. Other functions are also possible according to examples of the present invention. Note that one or more wireless connections may be used to convey the Z-directional information to the host device 100.

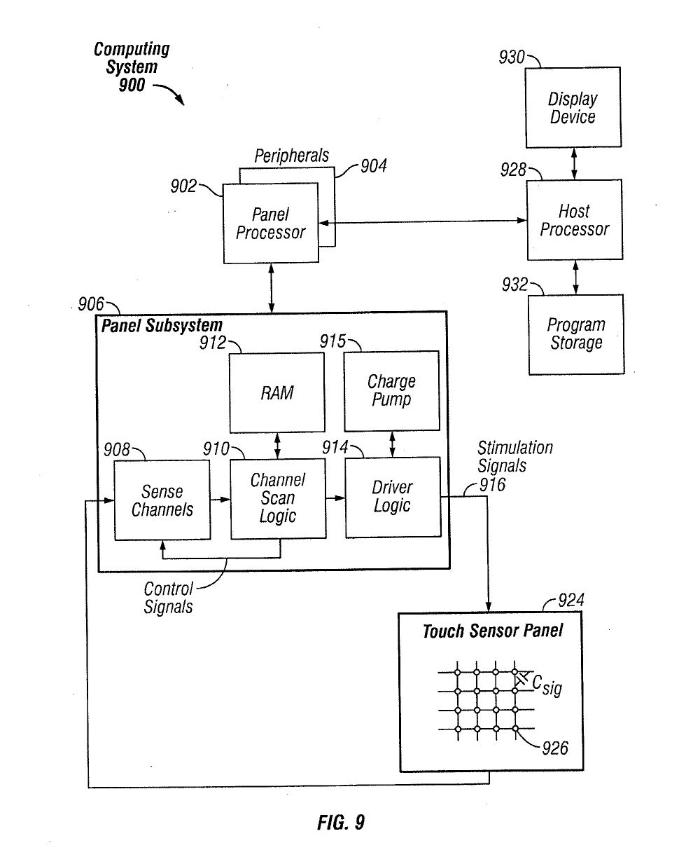

FIG. 9 illustrates exemplary computing system 900 adapted for use with one or more of the examples of the invention described above. Computing system 900 can include one or more panel processors 902 and peripherals 904, and panel subsystem 906. Peripherals 904 can include, but are not limited to, random access memory (RAM) or other types of memory or storage, watchdog timers and the like. Panel subsystem 906 can include, but is not limited to, one or more sense channels 908, channel scan logic 910 and driver logic 914. Channel scan logic 910 can access RAM 912, autonomously read data from the sense channels and provide control for the sense channels. In addition, channel scan logic 910 can control driver logic 914 to generate stimulation signals 916 at various frequencies and phases that can be selectively applied to drive lines of touch sensor panel 924. In some examples, panel subsystem 906, panel processor 902 and peripherals 904 can be integrated into a single application specific integrated circuit (ASIC).

Touch sensor panel 924 can include a capacitive sensing medium having a plurality of drive lines and a plurality of sense lines, although other sensing media can also be used. Additionally, one or more of the drive lines may be adapted to operate in sense mode according to various examples of the invention. Each intersection of drive and sense lines can represent a capacitive sensing node and can be viewed as picture element (pixel) 926, which can be particularly useful when touch sensor panel 924 is viewed as capturing an “image” of touch. (In other words, after panel subsystem 906 has determined whether a touch event has been detected at each touch sensor in the touch sensor panel, the pattern of touch sensors in the multi-touch panel at which a touch event occurred can be viewed as an “image” of touch (e.g. a pattern of fingers touching the panel).) Each sense line of touch sensor panel 924 can drive sense channel 908 (also referred to herein as an event detection and demodulation circuit) in panel subsystem 906.

Computing system 900 can also include host processor 928 for receiving outputs from panel processor 902 and performing actions based on the outputs that can include, but are not limited to, moving an object such as a cursor or pointer, scrolling or panning, adjusting control settings, opening a file or document, viewing a menu, making a selection, executing instructions, operating a peripheral device connected to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 928 can also perform additional functions that may not be related to panel processing, and can be connected to program storage 932 and display device 930 such as an LCD display for providing a UI to a user of the device. Display device 930 together with touch sensor panel 924, when located partially or entirely under the touch sensor panel, can form touch screen 918.

Note that one or more of the functions described above can be performed by firmware stored in memory (e.g. one of the peripherals 904 in FIG. 9) and executed by panel processor 902, or stored in program storage 932 and executed by host processor 928. The firmware can also be stored and/or transported within any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any medium that can contain or store the program for use by or in connection with the instruction execution system, apparatus, or device. The computer readable medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport readable medium can include, but is not limited to, an electronic, magnetic, optical, electromagnetic or infrared wired or wireless propagation medium.

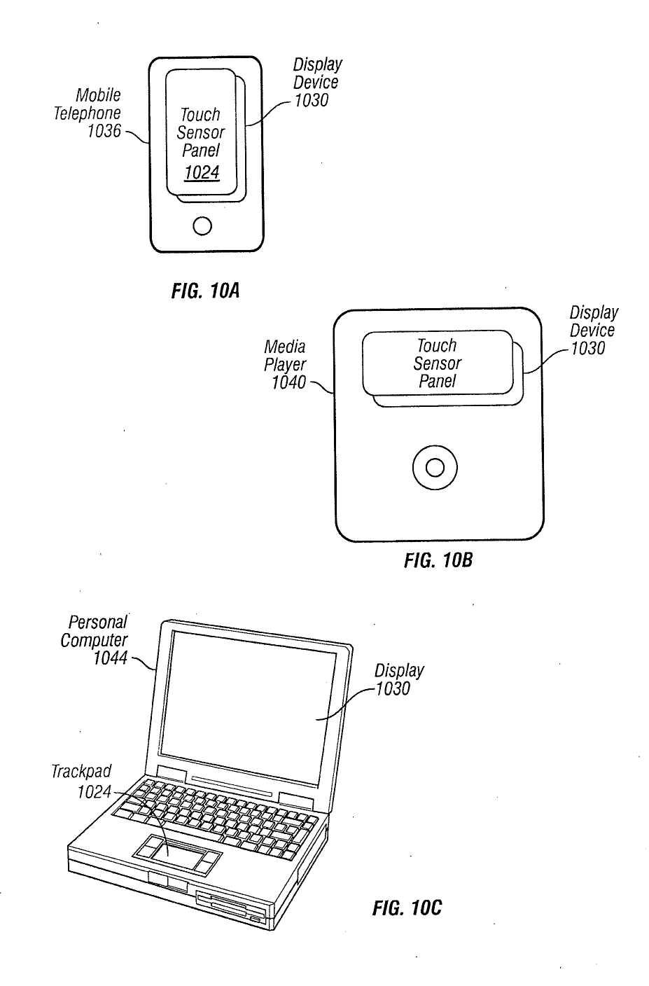

FIG. 10A illustrates exemplary mobile telephone 1036 that can include touch sensor panel 1024 and display device 1030, the touch sensor panel adapted for use with a stylus according to examples of the invention.

FIG. 10B illustrates exemplary digital media player 1040 that can include touch sensor panel 1024 and display device 1030, the touch sensor panel adapted for use with a stylus according to examples of the invention.

FIG. 10C illustrates exemplary personal computer 1044 that can include touch sensor panel (trackpad) 1024 and display 1030, the touch sensor panel and/or display of the personal computer (in examples where the display is part of a touch screen) adapted for use with a stylus according to examples of the invention. The mobile telephone, media player and personal computer of FIGS. 10A, 10B and 10C can increase computational efficiency and preserve power by utilizing the stylus to provide stimulus signals for one or more sensory electrodes.

Although examples of this invention have been fully described with reference to the accompanying drawings, it is to be noted that various changes and modifications will become apparent to those skilled in the art. Such changes and modifications are to be understood as being included within the scope of examples of this invention as defined by the appended claims.

What is claimed is:

1. An apparatus for providing input to a capacitive sensor array, the apparatus comprising:
a shaft;
a pivot structure connected to one end of the shaft; and
an actuator connected to the pivot structure, wherein the shaft is adapted to pivot about the pivot structure to enable the actuator to maintain contact with a surface as the shaft is moved through different orientations,
wherein a size of the actuator is selected so as to enable detection by one or more sensors of the capacitive sensor array upon contact with the surface;
wherein the one or more sensors comprises a force or angle sensor; and
wherein the apparatus is connected to a ground via a conductive element and adapted to receive power from a power source.

2. The apparatus of claim 1, wherein the powered apparatus is configured for increasing a voltage of the actuator and a strength of electric fields generated by the actuator and detectable by the one or more sensors in the capacitive sensor array.

3. The apparatus of claim 2, the one or more sensors is used for gathering position or orientation data about the apparatus.

4. The apparatus of claim 2, the one or more sensors is used for receiving stylus functionality input from a user.

5. The apparatus of claim 2, wherein the apparatus is adapted to transmit data indicative of the state of the one or more sensors to the capacitive sensor array via a stimulus frequency.

6. The apparatus of claim 2, wherein the apparatus is adapted to transmit data indicative of the state of the one or more sensors to the capacitive sensor array via a stimulating voltage level.

7. A capacitive sensor array capable of detecting a touch event, comprising:
a plurality of spatially separated first lines arranged in a first orientation; and
a plurality of spatially separated second lines arranged in a second orientation different from the first orientation, each of the first lines connected to a charge amplifier;
wherein the plurality of first lines are selectively configurable for switching between (1) a drive mode in which the first lines are connected to stimulation signals to detect touch events from a passive object, and (2) a sense mode in which the first lines are connected to charge amplifiers to detect touch events from a powered stylus generating the stimulation signals.

8. The capacitive sensor array of claim 7, further comprising a processor adapted to configure the plurality of first lines based upon input provided from the capacitive sensor array.

9. The capacitive sensor array of claim 7, further comprising a processor adapted to select the drive mode if a touch event has a region of contact corresponding to a finger.

10. The capacitive sensor array of claim 7, further comprising a processor adapted to select the drive mode if a plurality of touch events are detected.

11. A method of enabling input detection in a sensor array optimized for touch input, the method comprising:
driving one or more sensors in the sensor array with an articulated device when a contact structure of the articulated device makes contact with a surface;
determining a set of one or more sensors that have been driven as a result of the contact;
generating input based at least in part upon the set of driven sensors; and
determining a mode of operation for the sensor array, wherein the mode of operation is based at least in part upon characteristics of a calculated centroid.

12. The method of claim 11, wherein generating the input is further based upon the state of one or more sensors comprised within the articulated device.

13. The method of claim 12 further comprising determining the state of one or more sensors comprised within the articulated device via a stimulating frequency.

14. The method of claim 12 further comprising determining the state of one or more sensors comprised within the articulated device via a stimulating voltage level.

15. The method of claim 11, wherein the articulated device comprises a contact member adapted to drive a sufficient number of the one or more sensors so as to enable calculation of a centroid irrespective of a position of contact with the surface.

16. The method of claim 11, wherein determining the set of one or more sensors that have been driven as a result of the contact comprises filtering electrical noise from a signal pattern.
